(19) United States
(12) Patent Application Publication
(10) Pub. No.: US 2017/0010568 A1
(43) Pub. Date: Jan. 12, 2017

(54) IMAGE HEATING APPARATUS

(71) Applicant: CANON KABUSHIKI KAISHA, Tokyo (JP)

(72) Inventor: Takeshi Kozuma, Abiko-shi (JP)

(21) Appl. No.: 15/203,985

(22) Filed: Jul. 7, 2016

(30) Foreign Application Priority Data
Jul. 8, 2015 (JP) 2015-136939

(51) Int. Cl. G03G 15/20

(52) U.S. Cl. CPC G03G 15/2028

(57) ABSTRACT

An image heating apparatus includes first and second rotatable members configured to form a nip for heating a toner on a sheet; a compressor; an air nozzle configured to blow air which is compressed by the compressor, to the first rotatable member; and a supplying mechanism configured to supply the air which is compressed by the compressor, to the air nozzle. The supplying mechanism includes a pressure adjusting valve configured to adjust an inside pressure and a metal pipe configured to form at least a part of an air supply passage from the compressor to the pressure adjusting valve.

### FIELD OF THE INVENTION AND RELATED ART

The present invention relates to an image heating apparatus for heating a toner image on a sheet.

This image heating apparatus is usable in image forming apparatuses such as a copying machine, a printer, a facsimile machine and a multi-function machine having a plurality of functions of these machines.

Japanese Laid-Open Patent Application (JP-A) SHO60-247672 and JP-A 2007-094327 disclose that compressed air is blown to a fixing device (image heating apparatus) in order to separate a recording material (sheet) from the fixing device. This is effective in the case where an image is formed on thin paper which is fragile or limp.

A temperature of gas is taken into a compressor becomes high in a step of generating compressed air. For example, in the case where the air of a normal temperature (25° C.) and a normal pressure (0.1 MPa) is compressed to about 0.4 MPa, a temperature of a resultant gas is about 110° C. to about 120° C.

When such a high-temperature air is caused to flow into a pipe (gas flow passage), a temperature of a pressure adjusting valve provided in a piping passage increases and becomes a generating factor of noise.

### SUMMARY OF THE INVENTION

According to an aspect of the present invention, there is provided an image heating apparatus comprising: first and second rotatable members configured to form a nip for heating a toner on a sheet; a compressor; an air nozzle configured to blow air which is compressed by the compressor, to the first rotatable member; and a supplying mechanism configured to supply the air which is compressed by the compressor, to the air nozzle, wherein the supplying mechanism includes a pressure adjusting valve configured to adjust an inside pressure and a metal pipe configured to form at least a part of an air supply passage from the compressor to the pressure adjusting valve.

Further features of the present invention will become apparent from the following description of exemplary embodiments with reference to the attached drawings.

### BRIEF DESCRIPTION OF THE DRAWINGS

In FIG. 1, (a) to (c) are illustrations of an air supplying constitution in an embodiment.

In FIG. 2, (a) and (b) are structural illustrations of a fixing device in the embodiment.

FIG. 3 is an illustration of an image forming apparatus in the embodiment.

FIG. 4 is a block diagram of a control system.

FIG. 5 is a flowchart of control of air supply.

### DESCRIPTION OF THE EMBODIMENTS

An embodiment of the present invention will be described below, but the present invention is not limited thereto although the embodiment is an example of a preferred embodiment of the present invention.

### Embodiment

### [Image Forming Apparatus]

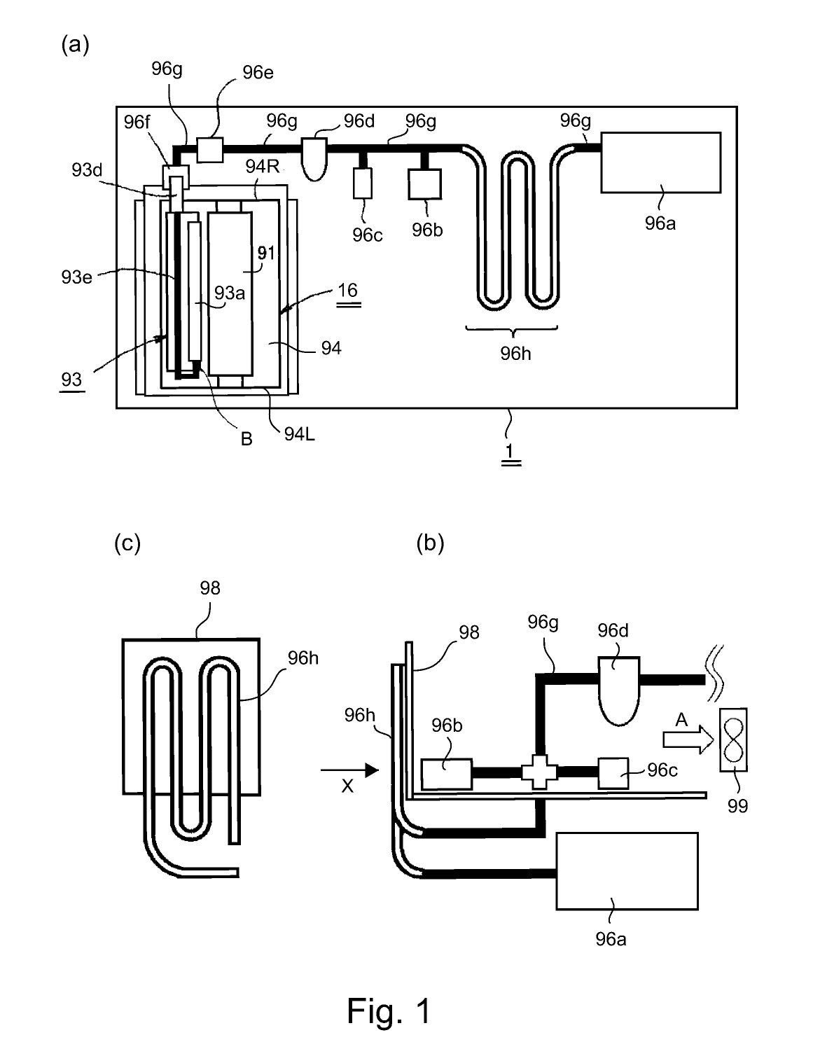

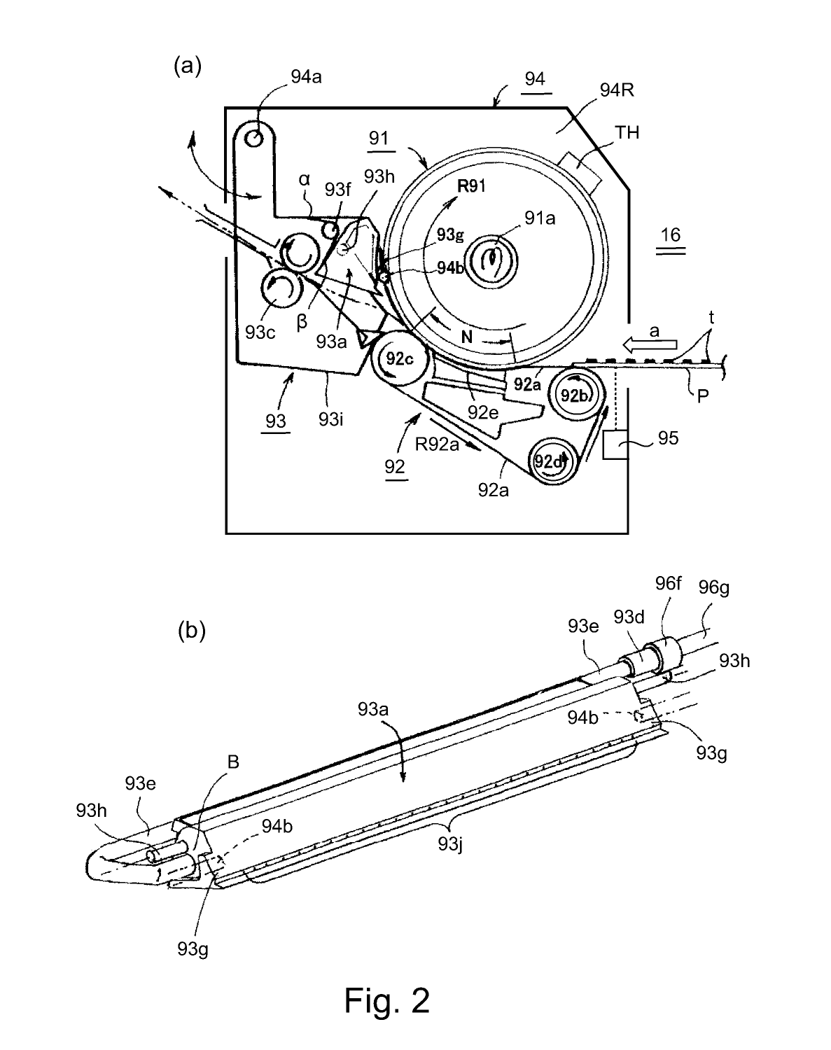

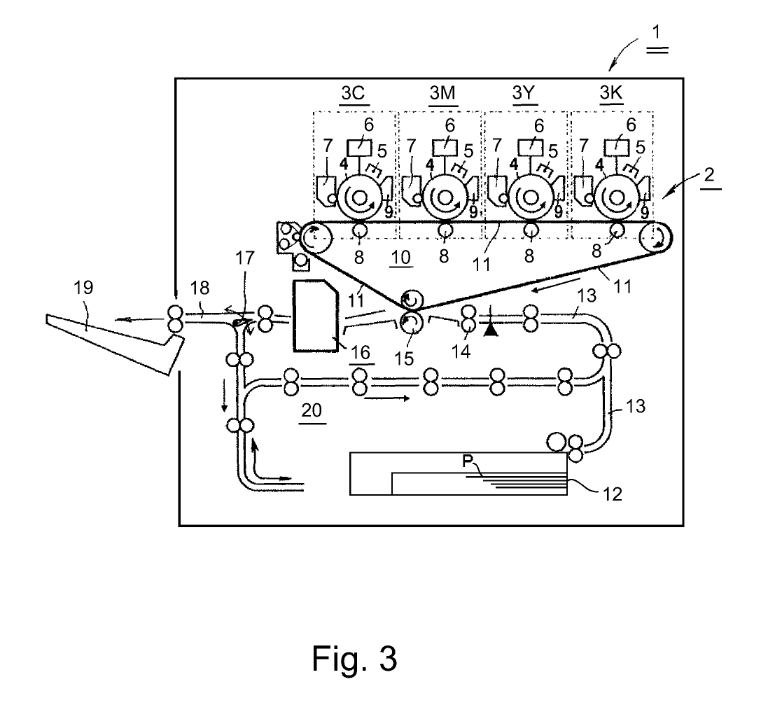

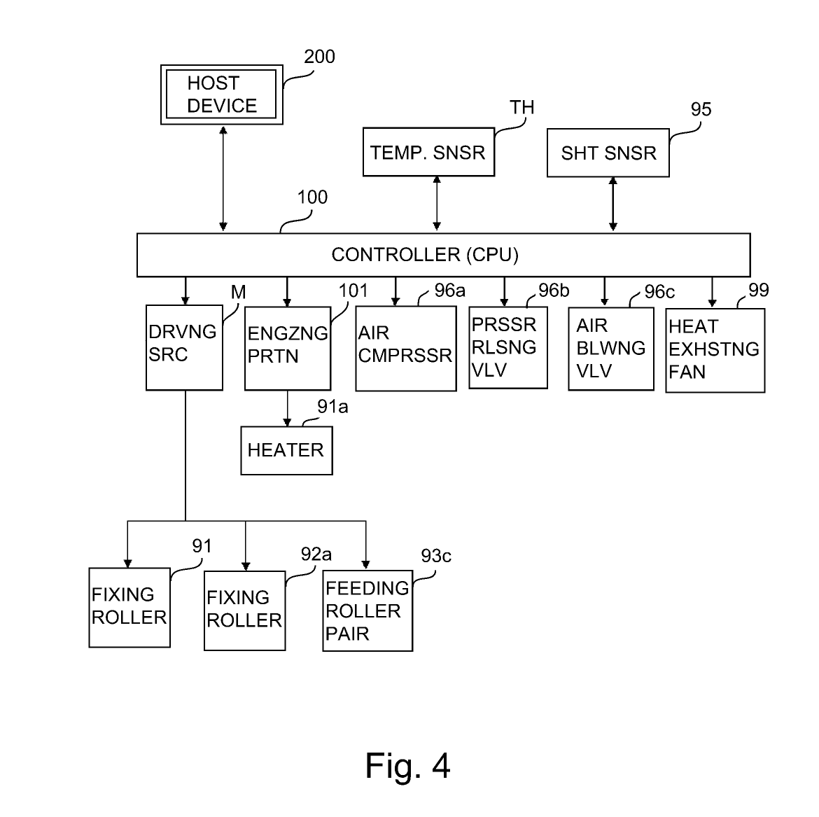

FIG. 3 is a schematic structural view of an example of an image forming apparatus 1 in which a fixing device 16 according to the present invention is mounted, and FIG. 4 is a block diagram of a control system. The image forming apparatus 1 is a tandem color electrophotographic printer of an intermediary transfer type in which the image forming apparatus 1 is operable on the basis of an image forming job inputted from an external host device 200, such as a personal computer, into a controller 100 and is capable of forming an image on a recording material (sheet) P. A structure of this printer is well known in the art, and therefore, will be described briefly.

An image forming portion 2 includes four image forming units 3 (3C, 3M, 3Y, 3K) and an intermediary transfer belt unit 10. Each of the image forming units 3 includes a photosensitive drum 4, a charger 5, a laser scanner 6, a developing device 7, a primary transfer charger 8, a cleaner 9 and so on, and the image forming units 3C, 3M, 3Y and 3K form toner images of cyan (C), magenta (M), yellow (Y) and black (K), respectively. Then, the four color toner images are successively primary-transferred superposedly from the photosensitive drums 4 of the image forming units 3 onto an intermediary transfer belt 11, so that a full-color toner image is formed on the belt 11.

The toner image is secondary-transferred from the belt 11 onto the sheet P at a secondary transfer nip which is a press-contact portion between the belt 11 and a secondary transfer roller 15. The sheet P is separated and fed one by one from a sheet feeding cassette 12 and is introduced into the secondary transfer nip at predetermined control timing through a feeding path 13 including a registration roller pair 14. Then, the sheet P on which the toner images is transferred is introduced into the fixing device 16, where the toner image is heated and pressed and is fixed on the sheet (recording material) P.

The sheet P which come out of the fixing device 16 and on which the image has already been fixed passes through an upper surface side of a flapper 17 and then is introduced to a feeding path 18, and then is discharged onto a tray 19. In the case of double-sided printing, the sheet P which come out of the fixing device 16 and on which the image has already been formed on the first surface is introduced into a feeding mechanism 20 for double-sided printing by switching of the flapper 17 and pass through the feeding path 13 again and then is fed to the transfer nip in a state in which the sheet P is turned upside down. As a result, the sheet P on which the images are

formed on both surfaces is discharged on the tray 19.

### [Fixing Device]

In FIG. 2, (a) is a schematic cross-sectional view of a principal part of the fixing device 16 in this embodiment. The fixing device 16 is roughly includes a fixing roller 91 as a first rotatable member, a belt unit 92 including a fixing belt 92a as a second rotatable member forming a nip N in co-operation with the fixing roller 91, a sheet discharging unit 93 and a device frame 94.

### (1) Fixing Roller

The fixing roller 91 includes a cylindrical core metal which is 77 mm in outer diameter, 6 mm in thickness and 350 mm in length and which is formed of metal (aluminum in this embodiment). On the core metal, as an elastic layer, a layer of a silicone rubber (JIS-A hardness: 20 degrees in this embodiment) is coated in a thickness of 1.5 mm. On the elastic layer, in order to improve a parting property with the toner, as a heat-resistant parting layer, a layer of fluorine-containing resin (PFA tube in this embodiment) is coated in a thickness of 50 μm.

The fixing roller 91 is rotatably supported between opposing side plates 94L and 94R of the device frame 94 in one end side (front side) and the other end side (rear side) ((a) of FIG. 1). The fixing roller 91 is rotationally driven at a predetermined speed, e.g., at a peripheral speed of 500 mm/sec in the clockwise direction of an arrow R91 by a driving force of a driving source M controlled by the controller 100.

Inside the core metal of the fixing roller 91, as a heat generating member, e.g., a halogen heater 91a having rated power of 1200 W is provided. The heater 91a generates heat by being supplied with electric power from an electric power supplying portion 101 controlled by the controller 100 and heats the fixing roller 91 from an inside of the fixing roller 91. A surface temperature of the heated fixing roller 91 is detected by a temperature sensor TH such as a thermistor, so that electrical detection temperature information is inputted into the controller 100. On the basis of the inputted detection temperature information, the controller 100 controls the temperature by controlling electric power supplied from the electric power supplying portion 101 to the heater 91a so that the surface temperature of the fixing roller 91 is raised and maintained at a predetermined temperature.

### (2) Belt Unit

The belt unit 92 is provided under the fixing roller 91 and includes the fixing belt 92a, an entrance roller 92b, a separation roller 92c, a steering roller 92d and a pressing pad 92e.

The fixing belt 92a is a heat-resistant endless belt having flexibility and is formed by coating a 200 μm-thick silicone rubber layer on a 100 μm-thick polyimide base layer, and is 70 mm in diameter. The fixing belt 92a is stretched by the entrance roller 92b, the separation roller 92c, the steering roller 92d and the pressing pad 92e. The fixing belt 92a is configured to be rotated in the counterclockwise direction of an arrow 92a at a peripheral speed substantially corresponding to the rotational speed of the fixing roller 91 by a driving force inputted from the driving source M into the separation roller 92c.

The separation roller 92c and the pressing pad 92e press the fixing belt 92a toward the fixing roller 91, so that a broad nip N is formed with respect to a sheet feeding direction a between the fixing roller 91 and the fixing belt 92a. In this embodiment, pressure application is effected so that 490 N (50 kgf) is applied to the pressing pad 92e and 490 N (50 kgf) is applied to the separation roller 92c.

### (3) Sheet Discharging Unit

The sheet discharging unit 93 for discharging the sheet P, passed through the nip N, to an outside of the fixing device 16 is provided in a position downstream of the nip N with respect to the sheet feeding direction a. The sheet discharging unit 93 includes a unit frame 93: in which an air nozzle 93a as a gas discharging portion for blowing gas for separating the sheet P from the fixing roller 91 and a feeding roller pair 93c for discharging the sheet P, separated from the fixing roller 91, to an outside of the fixing device 16 are provided.

The air nozzle 93a blows air (gas) toward the fixing roller 91 in order to separate the sheet P, after passed through the nip N, from the fixing roller 91. That is, the air nozzle 93a is an air separation mechanism for blowing air to a surface portion of the fixing roller 91 in the neighborhood of a sheet entrance portion of the nip N in a side downstream of the sheet entrance portion with respect to a rotational direction of the fixing roller 91.

The sheet discharging unit 93 (unit frame 93i) is mounted rotatably about a supporting shaft 94a between the opposing side plates 94L and 94R of the device frame 94. As a result, the sheet discharging unit 93 is movable about the supporting shaft 94a between a placement position (state position of FIG. 1) where the fixing device 16 can perform a fixing operation and a retracted position where the sheet discharging unit 93 is largely retracted and moved rearward from the fixing roller 91. The retracted position of the sheet discharging unit 93 is an outside of the device frame 94.

When the sheet P jammed in the fixing device 16, a user moves the sheet discharging unit 93 to the retracted position. As a result, a downstream side of the fixing device 16 is opened in a degree larger than the nip N, so that clearance (removal) of the jammed paper (sheet) can be facilitated.

In FIG. 2, (b) is a perspective view of an outer appearance of the air nozzle 93a. In this embodiment, the air nozzle 93a is a hollow duct member which is long in a widthwise direction of the fixing roller 91 and which is formed of aluminum. On a surface opposing the fixing roller 91, a plurality of nozzle holes 93j of about 0.5-1.0 mm in diameter are provided along a longitudinal direction with predetermined intervals. Into the hollow portion of the air nozzle 93a, compressed air is introduced, so that the air is blown from the nozzle holes 93j toward the fixing roller 91. An air supplying constitution to the air nozzle 93a will be described later.

The air nozzle 93a is disposed in parallel to the fixing roller 91 while a side thereof where the nozzle holes 93j opposes the fixing roller 91, and is supported rotatably about a supporting shaft 93h between the opposing side plates in one end side and the other end side of the unit frame 93i of the sheet discharging unit 93. Further, the air nozzle 93a is urged and rotated about the supporting shaft 93h toward the fixing roller 91 by a movable end β of a helical spring 93f having a fixed end α.

Positioning pins 94b are fixed in the device frame 94 side, and when the sheet discharging unit 93 is moved to the placement position, abutting surfaces 93g in the air nozzle 93a side abut against the pins 94b. As a result, in a state in which the sheet discharging unit 93 is located at the placement position, the air nozzle 93a is positioned in a state opposing the fixing roller 91 with a predetermined gap (spacing).

The feeding roller pair 93c is, in a state in which the sheet discharging unit 93a is located at the placement position, connected with a driving portion (not shown) in the device frame 94 side at a driven portion (not shown) in the sheet discharging unit 93a side. Further, the driving force is inputted from the driving source M, whereby the feeding roller pair 93c is rotationally driven in a sheet discharging direction at a predetermined peripheral speed. When the sheet discharging unit 93a is moved to the retracted position, the driven portion is spaced from the driving portion.

### (4) Fixing Operation

In a state in which the fixing roller 91 and the feeding roller pair 93 are rotationally driven and in which the fixing roller 91 is raised and maintained at the predetermined temperature, the sheet P carrying unfixed toner images t are introduced from the image forming portion 2 side into the nip N. The sheet P is nipped and fed through the nip N in contact with the surface of the fixing roller 91 at a toner image carrying surface thereof, so that the toner images t on the sheet (recording material) P are fixed as fixed images on the surface of the sheet P by heat and nip pressure.

The sheet P coming out of the nip N is successively separated from the surface of the fixing roller 91 by pressure (pressing force) of the separation roller 92c and is relayed to the feeding roller pair 93c, and then is fed and discharged from the fixing device 16. In the case where a basis weight of the sheet P introduced into the fixing device 16 is not less than a predetermined basis weight, as described later, compressed air is introduced into the air nozzle 93a at predetermined control timing. As a result, even a sheet having a small basis weight is effectively separated from fixing roller 91 by a separating action by the pressure of the separation roller 92c and an air separating action in combination.

### (5) Air Supplying Constitution

A constitution of the air supplying mechanism to the air nozzle 93a will be described with reference to FIG. 1 and (b) of FIG. 2. To a portion B of the air nozzle 93a in one end side, an end of an air tube 93e is connected, and the air tube 93e is extended to the other end of the air nozzle 93a via a rear side of the air nozzle 93a, and thus is connected to a fixing-side coupler 93d. The air tube 93e is a tube member consisting of an elastic member. The air tube 93e and the fixing-side coupler 93d are incorporated in the sheet discharging unit 93, and even when the sheet discharging unit 93 is rotated relative to the device frame 94, the air tube 93e consisting of the elastic member does not generate bending and deformation.

In FIG. 1, (a) is a schematic view showing a cross-section of the image forming apparatus 1 as seen from above, and shows the fixing device 16 and the air supplying constitution. An air compressor (air pump) 96a as a compressed portion for compressing the air is provided. The air compressor 96a and the fixing-side coupler 93d of the air nozzle 93a are connected by a group of pipes constituting a gas flow passage (hereinafter referred to as piping). This group of pipes is constituted by a rubber tube member 96g which is an elastic member and a metal pipe member 96h.

A terminal of the piping in a side opposite from the air compressor 96a side is connected to the fixing-side coupler 93d via a main assembly-side coupler 96f. The main assembly-side coupler 96f is a coupling member for establishing piping connection to the air nozzle 93a inside the sheet discharging unit 93 by being connected with the fixing-side coupler 93d.

The piping is provided successively provided with a pressure releasing solenoid (electromagnetic) valve 96b, a pressure adjusting valve (relief valve) 96c, an air filter 96 and air blowing solenoid valve 96e from an upstream side toward a downstream side of the air flow passage.

The pressure releasing solenoid valve 96b is a valve used for releasing air pressure (gas pressure) in the piping and is controlled by the controller 100. The pressure adjusting valve 96c is a pressure adjusting portion for adjusting and maintaining the air pressure in the piping at a predetermined pressure. The air filter 96d separates and removes drains, dirt and dusts in the piping. The air blowing solenoid valve 96e is a switching portion for switching whether or not the air in the piping (gas in the flow passage) adjusted to the predetermined pressure by the pressure adjusting valve 96c is opened, and is open/close-controlled by the controller 100.

Of the piping, at least a part of the piping in a section connecting from the air compressor 96a to the pressure adjusting valve 96c is formed of metal.

In this embodiment, the piping between the air compressor 96a and the pressure adjusting valve 96c is constituted, as a cooling pipe portion, by a pipe member 96h formed of metal, such as aluminum or copper, excellent in thermal conductivity. Other piping portions are constituted by tube members 96g consisting of an elastic member.

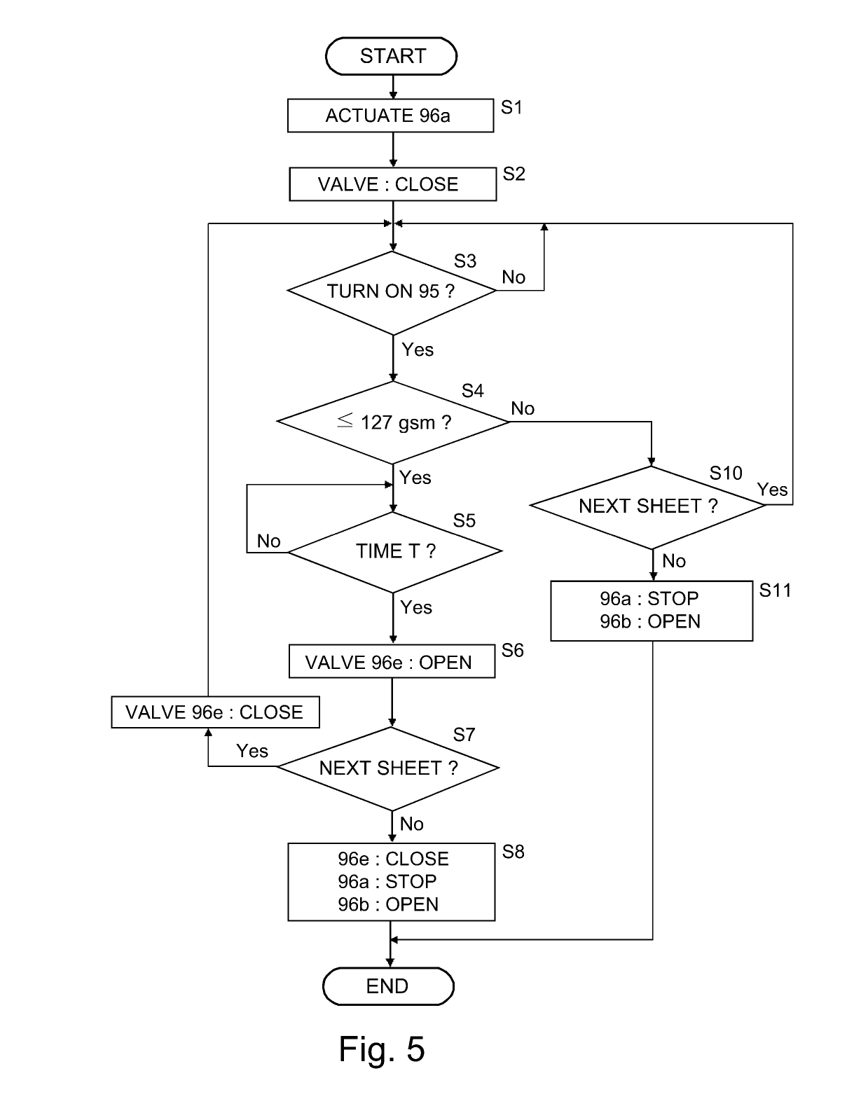

FIG. 5 is a flowchart of control of air supplying to the air nozzle 93a. The controller opens the pressure releasing solenoid valve 96b and closes the air blowing solenoid valve 96e during non-drive of the air compressor 96a.

The controller 100 actuates the air compressor 96a on the basis of a start signal of an image forming job (S1), and thereafter closes the pressure releasing solenoid valve 96b (S2). As a result, cooling gas (compressed air) having a predetermined pressure adjusted by the pressure adjusting valve 96c is accumulated in a piping portion from the air compressor 96a to the air blowing solenoid valve 96e. In this embodiment, the pressure adjusting valve 96c is adjusted so that the pressure in the piping is 0.2-0.3 MPa.

When the image forming portion 2 performs an image forming operation and the sheet P is sent into the fixing device 16, a sheet sensor (recording material detecting means) 95 provided at a sheet entrance portion of the fixing device 16 is turned on by detecting that a leading end of the sheet P reaches the sheet entrance portion (S3). The sheet sensor 95 is turned off by passing of a trailing end of the sheet P through the sheet entrance portion.

In the case where the sheet P introduced in the fixing device 16 has the basis weight not more than a predetermined basis weight (not more than 127 gsm in this embodiment) for which air separation of the sheet P is required, on the basis of turning-on timing of the sheet sensor 95, the controller opens the air blowing solenoid valve 96e after a lapse of a predetermined time T (S4-S6).

In this embodiment, the basis weight of the sheet P sent into the fixing device 16 is recognized from information, of a species of the sheet P used, contained in information of the image forming job sent from the host device 200. Further, the predetermined time is a time required until the sheet P detected by the sheet sensor 95 at the leading end thereof is further fed and the leading end reaches a sheet exit portion of the nip N.

The air blowing solenoid valve 96e is opened at control timing as described above, so that the compressed air is blown to the reading end of the sheet P, come out of the sheet exit portion of the nip N, at a speed of about 300 m/sec. As a result, even the sheet having the small basis weight is effectively separated by the separating action of the pressure by the separation roller 92c and the air separating action in combination. The air blowing from the air nozzle 93a is continued until the sheet P completely passes through the nip N in this embodiment.

When there is no subsequent sheet, the controller 100 closes the air blowing solenoid valve 96e, stops the drive of the air compressor 96a and opens the pressure releasing solenoid valve 96b (S7, S8). Further, in the step S7, in the case where there is a subsequent sheet, the controller 100 closes the air blowing solenoid valve 96e (S9), and the sequence returns to the step S3.

In the step S4, in the case where the basis weight of the sheet P sent into the fixing device 16 is more than the predetermined basis weight, in this embodiment, the air separation of the sheet P is not needed, and the fixing operation is performed without supplying the air to the air nozzle 93a. Further, when there is no subsequent sheet, the controller 100 stops the drive of the air compressor 96a and opens the pressure releasing solenoid valve 96b (S10, S11). When there is a subsequent sheet in the step S10, the sequence returns to the step S3.

Here, as described above, the gas introduced into the piping by the drive of the air compressor 96a is a high-temperature gas by heat of compression. Further, when the temperature of the compressed gas in the piping is in a high state such that the temperature is, e.g., not less than 100° C., there is a liability that air pressure (pneumatic) parts such as the pressure releasing solenoid valve 96b, the pressure adjusting valve 96c and the air filter 96d are damaged. Or, there is a liability that a behavior of a valve body when the air passes through the inside of the pressure adjusting valve 96c causes abnormality and thus high-frequency noise is caused when the valve body hits a (valve) seat.

In order to suppress this noise, in this embodiment, as described above, the piping between the air compressor 96a and the pressure releasing solenoid valve 96b is constituted by the pipe member 96h formed of metal as the cooling pipe portion. By this constitution, the high-temperature air introduced into the piping by the drive of the air compressor 96a is efficiently cooled during passing thereof through the inside of the pipe member 96h, so that the temperature of the air flowing into the air pressure parts is not more than 60° C.

In order to sufficiently cool the compressed air, the pipe member 96h as the cooling pipe portion is required to have an air flow passage length to some extent. In this embodiment, the pipe member 96h (the air flow passage) is provided with a plurality of U-shaped flexed portions (hairpin portions) (hereinafter referred to as a serpentine portion). As a result, the piping having a long flow passage can be accommodated in a narrow space, so that it is possible to suppress upsizing of the image forming apparatus.

Mounting constitutions of the pipe member 96h and other air pressure parts are specifically shown in (b) and (c) of FIG. 1. The serpentine portion of the pipe member 96h is formed so that an axial center line of the pipe substantially exists on a single flat surface. This serpentine portion is hermetically fixed by a fixing member (spring member) to a flat surface portion of a partitioning plate 98 (metal partitioning plate in a casing of the image forming apparatus) as another (heat dissipating member having a surface substantially parallel to this flat surface. The partitioning plate 98 is formed of metal, and therefore, the partitioning plate 98 is used as an object to be subjected to heat conduction (heat dissipating member), so that heat can be efficiently taken from the compressed air.

Further, a fan 99 is provided in a side opposing the flat surface portion of the partitioning plate 98 via the pressure releasing solenoid valve 96b and the pressure adjusting valve 96c. The fan 99 generates an air stream in an arrow A in (b) of FIG. 1, so that the heat in the casing (space) of the image forming apparatus is dissipated (discharged) to the outside of the casing. By providing the fan 99 at a position opposing the partitioning plate 98 which is liable to accumulate the heat, the temperature of the compressed air can be lowered further efficiently. Also a constitution in which a heat dissipating fin is provided along a longitudinal direction of the pipe member 96h at an outer peripheral portion of the pipe member 96h is effective. In the following numerical value examples and numerical value ranges will be shown.

a: Piping length of member pipe (piping) 96: 2000 mm, preferably not less than 1000 mm in view of cooling efficiency of the compressed air.

b: Outer configuration of metal pipe 96h: 10 mm, preferably not more than 30 mm in view of the cooling efficiency of the compressed air.

c: Inner diameter of metal pipe 96h: 7 mm.

d: Piping length from pump 96a to relief valve 96c (metal piping+rubber piping): 4000 mm, it is desirable that a ratio of a length of the metal piping to a length of the piping from the pump 96a to the relief valve 96c is not less than 40%, preferably not less than 50%.

The metal piping 96h is high in cooling performance compared with a metal tank. The metal piping 96h is high in flexibility of a designed shape compared with the metal tank. Inside the metal piping 96h, water does not readily accumulate. The piping other than the metal piping 96h is a rubber tube, and therefore, absorbs vibration of the fixing device during valve opening. The piping other than the metal piping 96h is the rubber tube and thus is high in degree of freedom of piping (pipe arrangement).

As described above, the part 96h of the piping (gas flow passage) is formed of metal (metal pipe) excellent in thermal conductivity, so that the high-temperature gas compressed by the air compressor 96a is efficiently cooled until the gas reaches a position where the air pressure parts are provided. For that reason, in comparison with placement of the pressure tank, it is possible to suppress temperature rise of the pressure adjusting valve 96c and other air pressure parts 96b, 96d and 96e which are provided in the piping while remarkably maintaining a space saving property. Accordingly, a phenomenon that the pressure adjusting valve 96c generates the noise can be suppressed, and it is possible to decrease a risk of breakage of the pressure adjusting valve 96c and other air pressure parts 96b, 96d and 96e.

Incidentally, even when the flow passage length from the air compressor 96a to the pressure adjusting valve 96c is made long without using the metal pipe (piping) 96h, a certain effect of suppressing the temperature rise of the pressure adjusting valve 96c is obtained. However, a flow passage for that purpose becomes very long, so that a space necessary to ensure the flow passage increases and thus leads to upsizing of the fixing device.

### Other Embodiments

1) In the above, the device for heating and fixing the unfixed toner images formed on the recording material was described as an example of the fixing device adjust the present invention, but the present invention is also similarly applicable to the following device. For example, the present invention is applicable to a device for increasing a gloss (glossiness) of an image by heating and fixing again a toner image which is temporarily fixed on a recording material (herein, the device is referred to as the fixing device also in this case). Further, the present invention is also applicable to a device for fixing a toner image by pressure.
2) It is also possible to employ a device constitution in which the fixing belt 92a is used as a first rotatable member and the air for separating the sheet is blown to the fixing belt 92a and a device constitution in which the air for separating the sheet is blown to both of the fixing roller 91 and the fixing belt 92a.
3) It is also possible to employ a fixing device constitution in which both of the first and second rotatable members are rollers and a fixing device constitution in which both of the first and second rotatable members are endless belts.
4) The gas includes other gases, such as nitrogen gas and carbonic acid gas, other than the air.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-136939 filed on Jul. 8, 2015, which is hereby incorporated by reference herein in its entirety.

What is claimed is:

1. An image heating apparatus comprising:
first and second rotatable members configured to form a nip for heating a toner on a sheet;
a compressor;
an air nozzle configured to blow air which is compressed by said compressor, to said first rotatable member; and
a supplying mechanism configured to supply the air which is compressed by said compressor, to said air nozzle,
wherein said supplying mechanism includes a pressure adjusting valve configured to adjust an inside pressure and a metal pipe configured to form at least a part of an air supply passage from said compressor to said pressure adjusting valve.

2. An image heating apparatus according to claim 1, wherein the air supply passage includes a plurality of U-shaped portions.

3. An image heating apparatus according to claim 2, further comprising a heat dissipating plate and a member configured to bring said pipe into close contact with said heat dissipating plate.

4. An image heating apparatus according to claim 3, wherein said heat dissipating plate is formed of metal.

5. An image heating apparatus according to claim 3, further comprising a fan configured to cool said heat dissipating plate.

6. An image heating apparatus according to claim 1, further comprising a heat dissipating plate and a member configured to bring said pipe into close contact with said heat dissipating plate.

7. An image heating apparatus according to claim 6, wherein said heat dissipating plate is formed of metal.

8. An image heating apparatus according to claim 6, further comprising a fan configured to cool said heat dissipating plate.

9. An image heating apparatus according to claim 1, wherein a length of an air supplying passage by said pipe is not less than 40% of a length of the air supplying passage from said compressor to said pressure adjusting valve.

10. An image heating apparatus according to claim 9, wherein said supplying mechanism includes a rubber pipe.

11. An image heating apparatus according to claim 1, wherein a length of an air supplying passage by said pipe is not less than 50% of a length of the air supplying passage from said compressor to said pressure adjusting valve.

12. An image heating apparatus according to claim 11, wherein said supplying mechanism includes a rubber pipe.

13. An image heating apparatus according to claim 1, wherein said metal pipe dissipates the air so that a temperature of the air reaching said pressure adjusting valve is not more than 60° C.

14. An image heating apparatus according to claim 1, wherein said pressure adjusting valve includes a valve configured to switch whether or not the air adjusted by said pressure adjusting valve so that a pressure thereof is not more than a predetermined pressure is blown to said first rotatable member.
